(19) United States
(12) Patent Application Publication
(10) Pub. No.: US 2026/0089571 A1
(43) Pub. Date: Mar. 26, 2026

(54) METHOD, DEVICE, AND MEDIUM FOR RADIO SPECTRUM BINDING SERVICE

(71) Applicant: Verizon Patent and Licensing Inc., Basking Ridge, NJ (US)

(72) Inventors: David Taft, Keller, TX (US); Cindy Yuexin Dong, Bridgewater, NJ (US); Samirkumar Patel, Middlesex, NJ (US); Lap Tse, Marietta, GA (US)

(21) Appl. No.: 18/897,738

(22) Filed: Sep. 26, 2024

(51) Int. Cl. H04W 28/20; H04W 28/08; H04W 72/0453

(52) U.S. Cl. CPC H04W 28/20; H04W 28/0925; H04W 72/0453

(57) ABSTRACT

A method, a network device, and a non-transitory computer-readable storage medium are described in relation to an radio spectrum binding service. The service may include generating and provisioning binding information. The binding information may include radio frequencies correlated to applications or categories of applications associated with packet data unit sessions or radio frequencies correlated to applications or categories of applications associated with packet data unit sessions, and network slice identifiers. The service may include selecting and using the binding information for packet data unit sessions.

### BACKGROUND

Development and design of networks present certain challenges from a network-side perspective and an end device perspective. With respect to Next Generation (NG) wireless networks, such as Fifth Generation New Radio (5G NR) networks, various mechanisms and technologies may be used to ensure the delivery of certain performance metrics, such as minimal latency and packet loss, as well as high throughput and other types of network performance criteria.

### BRIEF DESCRIPTION OF THE DRAWINGS

FIG. 1 is a diagram illustrating an exemplary environment in which an exemplary embodiment of a radio spectrum binding service may be implemented;

FIG. 2A is a diagram illustrating an exemplary process of an exemplary embodiment of the radio spectrum binding service;

FIG. 2B is a diagram that illustrates an exemplary embodiment of binding information;

FIG. 3A is a diagram illustrating another exemplary process of an exemplary embodiment of the radio spectrum binding service;

FIG. 3B is a diagram that illustrates another exemplary embodiment of the binding information;

FIG. 4 is a diagram illustrating exemplary components of a device that may correspond to one or more of the devices illustrated and described herein;

FIG. 5 is a flow diagram illustrating an exemplary process of an exemplary embodiment of the radio spectrum binding service; and

FIG. 6 is a flow diagram illustrating another exemplary process of an exemplary embodiment of the radio spectrum binding service.

### DETAILED DESCRIPTION

The following detailed description refers to the accompanying drawings. The same reference numbers in different drawings may identify the same or similar elements. Also, the following detailed description does not limit the invention.

A wireless network, such as a 5G network, may offer various frequency bands, carriers, radio frequencies (RFs), and/or another type of segment of radio spectrum (simply referred to as radio frequency) that an end device may use for connectivity to an application service. The end device may establish and/or connect to the application service via a packet data unit (PDU) session, a network slice, a quality of service (QoS) flow, or the like, and a selected radio frequency. However, the capability to bind a radio frequency to a specific or type of PDU session, network slice, application service, or the like has not been implemented. Current network standards also do not address a nexus between radio frequency and PDU sessions, network slices, and the like.

According to exemplary embodiments, a radio spectrum binding service is described. According to an exemplary embodiment, the radio spectrum binding service may include binding a radio frequency to a PDU and/or a network slice. For example, binding information may include a mapping or a correlation between the radio frequency to a PDU session, a network slice, or both. According to some exemplary embodiments, the binding information may include priority values pertaining to candidate radio frequencies that may be used for a particular PDU session or network slice.

According to some exemplary embodiments, the correlation to the PDU session may relate to an end device application service or a category of an end application service with which the PDU session is associated, as described herein. According to an exemplary embodiment, the binding information may correlate other types of information with the radio frequency. For example, the radio spectrum binding service may correlate capability information associated with radio access devices and end devices, as described herein.

According to an exemplary embodiment, the radio spectrum binding service may use artificial intelligence and/or machine learning (AI/ML) logic to generate and optimize the binding information. For example, the AI/ML logic may dynamically modify the binding information in real or near-real time according to various types of criteria or objectives, as described herein. For example, the criteria may include the state of a network and/or a network device, radio frequency efficiency, and/or another configurable parameter or factor.

According to an exemplary embodiment, the binding information of the radio spectrum binding service may be provisioned in a core network, a radio access network, and at an end device. According to an exemplary embodiment, the radio spectrum binding service may use control plane (CP) messaging for provisioning and/or configuration of the binding information. According to an exemplary embodiment, an end device, which includes logic of the radio spectrum binding service, may select a radio frequency or a radio frequency and a network slice based on the binding information.

According to an exemplary embodiment, the radio spectrum binding service may provide binding information associated with the end device application service to the end device on a per request basis. For example, a network device or a network that includes logic of the radio spectrum binding service, may provide binding information to the end device responsive to a PDU session establishment request. According to another exemplary embodiment, the radio spectrum binding service may provide binding information for any and all end device application services associated with the end device via a single communication exchange (e.g., not on a per request basis).

In view of the foregoing, the radio spectrum binding service may improve radio spectrum utilization by leveraging the characteristics of radio frequencies to different types of applications, PDU sessions, and/or network slices and their associated performance metric characteristics. Additionally, the radio spectrum binding service may assist in the management and use of available radio frequencies by end devices and data transmission performance characteristics (e.g., higher uplink throughput, lower uplink throughput, etc.) that may match the user/application needs.

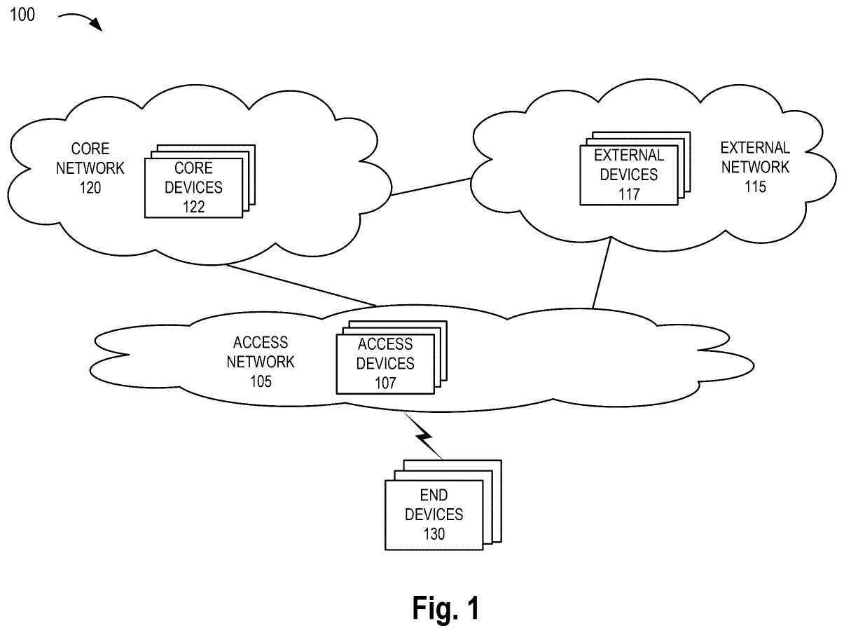

FIG. 1 is a diagram illustrating an exemplary environment 100 in which an exemplary embodiment of a radio spectrum binding service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually or generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network, or another type of network that may support a wireless service and/or an end device application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), client/server, peer-to-peer, etc.) and/or implemented with various networking approaches (e.g., logical, virtualization, network slicing, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number, type, and arrangement of communication links illustrated in environment 100 are exemplary.

Environment 100 may include various planes of communication including, for example, a control plane, a user plane (UP), a service plane, and a network management plane. Environment 100 may include other types of planes of communication. A message communicated in support of the radio spectrum binding service may use at least one of these planes of communication. According to various exemplary implementations, the interface of the network device may be a service-based interface, a reference point-based interface, an Open Radio Access Network (O-RAN) interface, a 5G interface, another generation of interface (e.g., 5G Advanced, Sixth Generation (6G), Seventh Generation (7G), etc.), or some other type of network interface (e.g., proprietary, etc.).

Access network 105 may include one or multiple networks of one or multiple types and technologies. For example, access network 105 may be implemented to include a Fifth Generation (5G) RAN, a future generation RAN (e.g., a Sixth Generation (6G) RAN, a Seventh Generation (7G) RAN, etc.), a centralized-RAN (C-RAN), a virtualized RAN (vRAN), an Open-RAN (O-RAN), and/or another type of access network. Access network 105 may include a legacy RAN (e.g., a Third Generation (3G) RAN, a Fourth Generation (4G) RAN, etc.). Access network 105 may communicate with and/or include other types of access networks, such as, for example, a Wi-Fi network, a local area network (LAN), a Citizens Broadband Radio System (CBRS) network, a cloud RAN, a self-organizing network (SON), a wired network (e.g., optical, cable, etc.), or another type of network that provides access to or can be used as an on-ramp to access network 105 and/or core network 120.

Access network 105 may include different and multiple functional splitting, such as options 1, 2, 3, 4, 5, 6, 7, or 8 that relate to combinations of access network 105 and core network 120 including an Evolved Packet Core (EPC) network and/or a Next Generation Core (NGC)/5G core network, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (COMP), various duplex schemes (e.g., frequency division duplex (FDD), time division duplex (TDD), half-duplex FDD (H-FDD), etc.), and/or another type of connectivity service (e.g., NSA NR, SA NR, etc.). Additionally, or alternatively, according to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a next generation Node B (gNB), an enhanced LTE (eLTE) evolved Node B (eNB), an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN gNB, O-RAN-eNB), a 5G ultra-wide band (UWB) node, and/or a future generation wireless access device (e.g., a 5G advanced wireless station, a 6G wireless station, a 7G wireless station, or another generation of wireless station). Access devices 107 may include a transport device (e.g., a router or similar network device).

Access device 107 may include other types of wireless access devices, such as a Wi-Fi device, a hotspot device, and/or a fixed wireless access customer premise equipment (FWA CPE), etc.) that provides a wireless access service. Additionally, access devices 107 may include a wired and/or an optical device (e.g., modem, wired access point, optical access point, Ethernet device, multiplexer, etc.) that provides network access and/or transport service.

According to some exemplary implementations, access device 107 may include a combined functionality of multiple RATs (e.g., 4G and 5G functionality, 5G and 5G Advanced functionality, 5G and 6G), etc.) via soft and hard bonding based on demands and needs. According to some exemplary implementations, access device 107 may include a split access device (e.g., a CU-control plane (CP), a CU-user plane (UP), etc.) or an integrated functionality, such as a CU-CP and a CU-UP, or other integrations of split RAN nodes. Access device 107 may be an indoor device or an outdoor device.

According to various exemplary implementations, access device 107 may include one or multiple sectors or antennas. The antenna may be implemented according to various configurations, such as single input single output (SISO), single input multiple output (SIMO), multiple input single output (MISO), multiple input multiple output (MIMO), massive MIMO, three dimensional (3D) and adaptive beamforming (also known as full-dimensional agile MIMO), two dimensional (2D) beamforming, antenna spacing, tilt (relative to the ground), radiation pattern, directivity, elevation, planar arrays, and so forth. Depending on the implementation, access device 107 may provide a wireless access service at a cell, a sector, a sub-sector/zone, carrier, and/or other configurable level. For example, the sub-sector/zone level may include multiple divisions of a geographic area of a sector relative to access device 107. By way of further example, the sector may be divided based on proximity to the antenna of access device 107 (e.g., near, mid, far) and/or another criterion. According to another example, radio coverage of a location may be divided based on a Military Grid Reference System (MGRS) or another type of grid system to produce geo-bins. The size and/or shape of each geo-bin may be configurable. The size and/or the shape of a geo-bin may depend on the types of access device 107 (e.g., small cell device versus gNB, etc.), attributes of access device 107 (e.g., antenna configuration, radio frequency band of beam, etc.), and/or other factors (e.g., terrain of the radio covered locale).

According to some exemplary embodiments, at least some of access devices 107, as described herein, include an exemplary embodiment of the radio spectrum binding service. For example, according to an exemplary embodiment, a RIC or similar type of wireless station controller device may include logic of the radio spectrum binding service. According to such an embodiment, the RIC may generate and provision binding information relative to another access device 107 (e.g., wireless station, such as a gNB, a DU, or the like) and/or end device 130, as described herein.

External network 115 may include one or multiple networks of one or multiple types and technologies that provide an application service. For example, external network 115 may be implemented using one or multiple technologies including, for example, network function virtualization (NFV), SDN, cloud computing, Infrastructure-as-a-Service (IaaS), Platform-as-a-Service (PaaS), Software-as-a-Service (Saas), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an Internet Protocol Multimedia Subsystem (IMS) network, a Rich Communication Service (RCS) network, a software-defined (SD) network, a virtual network, a packet-switched network, a data center, a data network, or another type of application service layer network that may provide access to and may host an end device application service.

Depending on the implementation, external network 115 may include various network devices such as external devices 117. For example, external devices 117 may include virtual network devices (e.g., virtualized network functions (VNFs), servers, host devices, application functions (AFs), application servers (ASs), server capability servers (SCSs), containers, hypervisors, virtual machines (VMs), pods, network function virtualization infrastructure (NFVI), and/or other types of virtualization elements, layers, hardware resources, operating systems, engines, etc.) that may be associated with application services for use by end devices 130. By way of further example, external devices 117 may include mass storage devices, transport devices, data center devices, NFV devices, SDN devices, cloud computing devices, platforms, and other types of network devices pertaining to various network-related functions (e.g., security, management, charging, billing, authentication, authorization, policy enforcement, development, etc.). Although not illustrated, external network 115 may include one or multiple types of core devices 122, as described herein.

External devices 117 may host one or multiple types of application services. For example, such application services may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, video calling, video conferencing, instant messaging), video streaming, fitness services, navigation services, online gaming, web services, and/or other types of wireless and/or wired application services. External devices 117 may also include other types of network devices that support the operation of external network 115 and the provisioning of application services, such as an orchestrator, an edge manager, an operations support system (OSS), a local domain name system (DNS), registries, and the like. External devices 117 may include non-virtual, logical, and/or physical network devices.

Core network 120 may include one or multiple networks of one or multiple network types and technologies. Core network 120 may include a complementary network of access network 105. For example, core network 120 may be implemented to include a 5G core network, a 5G Advanced core network, an EPC of an LTE network, an LTE-Advanced (LTE-A) network, and/or an LTE-A Pro network, a future generation core network (e.g., a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an access and mobility management function (AMF), a session management function (SMF), a unified data management (UDM) device, a unified data repository (UDR), an authentication server function (AUSF), a security anchor function (SEAF), a network slice selection function (NSSF), a network repository function (NRF), a policy control function (PCF), a network data analytics function (NWDAF), a network exposure function (NEF), a service capability exposure function (SCEF), a lifecycle management (LCM) device, a mobility management entity (MME), a packet data network gateway (PGW), an enhanced packet data gateway (ePDG), a wireless access gateway (WAG), a tunnel termination gateway (TTG), a serving gateway (SGW), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), a charging system (CS), a transport device, and/or a future generation core device 122 that may perform a similar function.

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-RAT functionality (e.g., 4G and 5G, 5G and 6G, 5G Advanced and 6G, 6G and 7G, etc.), such as an SMF with PGW control plane functionality (e.g., SMF+PGW-C), a UPF with PGW user plane functionality (e.g., UPF+PGW-U), and/or other combined nodes (e.g., an HSS with a UDM/UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

According to some exemplary embodiments, at least some of core devices 122, as described herein, include an exemplary embodiment of the radio spectrum binding service. For example, according to an exemplary embodiment, a PCF, a split PCF (e.g., an SM-PCF, a UE-PCF, or an AM-PCF), or a similar type of policy control device may include logic of the radio spectrum binding service. For example, the policy control device may generate and provision binding information relative to access device 107 (e.g., wireless station, such as a gNB, a DU, or the like) and/or end device 130, as described herein.

End device 130 may include a device that may have communication capabilities (e.g., wireless, wired, optical, etc.). End device 130 may or may not have computational capabilities. End device 130 may be implemented as a mobile device, a portable device, a stationary device (e.g., a non-mobile device and/or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, headgear, a band, etc.), a computer, a gaming device, a music device, an IoT device, a drone, a smart device, an autonomous vehicle, or another type of wireless device (e.g., another type of user equipment (UE)). End device 130 may or may not be configured to execute diverse types of software (e.g., applications, programs, etc.). The number and the types of software may vary among end devices 130. End device 130 may include “edge-aware” and/or “edge-unaware” application service clients. End device 130 may be implemented as a virtualized device in whole or in part. For purposes of description, end device 130 is not considered a network device.

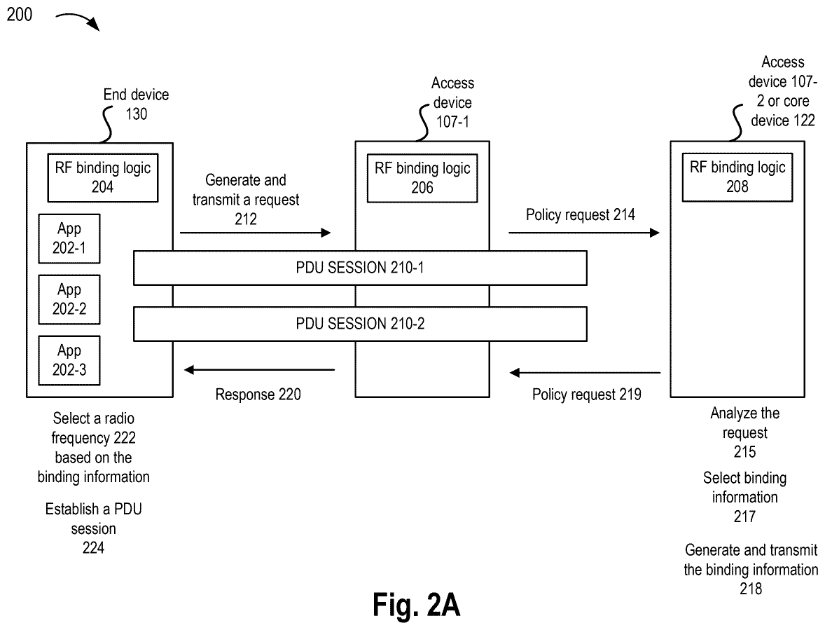

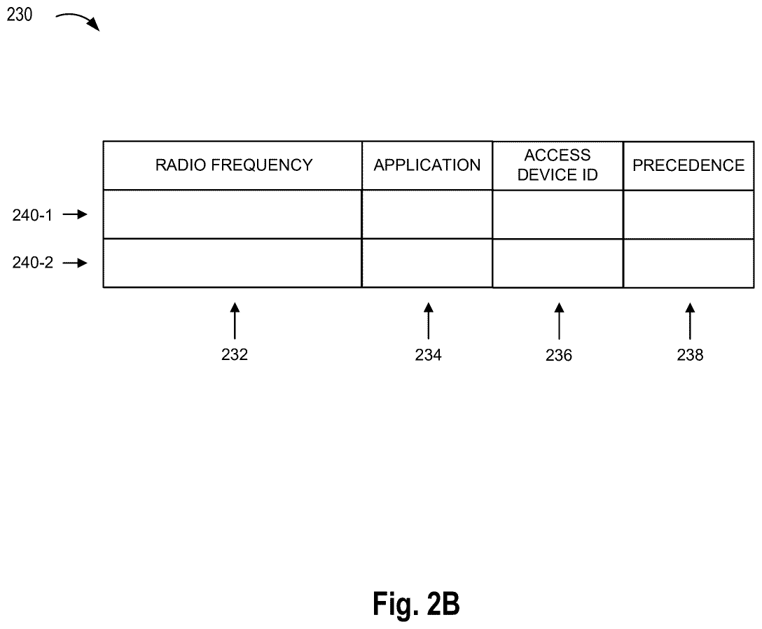

FIG. 2A is a diagram illustrating an exemplary process 200 of an exemplary embodiment of the radio spectrum binding service implemented in an exemplary environment. According to this example, the exemplary environment may be implemented to include end device 130, access device 107-1, and access device 107-2 or core device 122. According to exemplary embodiment, access device 107-1 may be implemented as a wireless station (e.g., integrated or split), such as a gNB or an RU+DU, for example, and access device 107-2 may be implemented as a RIC or similar type of RAN controller device (e.g., a BSC or the like). According to another exemplary embodiment in which access device 107-2 may be omitted or does not include radio spectrum binding service logic, core device 122 may be implemented as a PCF, a split PCF, or a similar type of policy control device. According to still other exemplary embodiments, access device 107-2 and/or core device 122 may be implemented as a lightweight and non-standard network device (e.g., a dedicated network device, a proprietary network device, etc.) that provides the radio spectrum binding service, as described herein.

Referring to FIG. 2A, assume that end device 130 includes applications 202-1 through 202-3 (also referred to collectively as applications 202 or individually or generally as application 202). The number of applications are exemplary and according to other exemplary scenarios, end device 130 may have fewer or an additional number of applications. According to some examples, application 202 may be a client-side application that provides an application service associated with an application service of external device 117, as described herein. According to an exemplary scenario, applications 202 may include applications of different types or categories (e.g., extreme real-time, video streaming, gaming, etc.) and associated QoS flow and/or performance metrics (e.g., 5G QoS Identifier (5QI), latency, throughput, bitrate, etc.).

End device 130 may further include RF binding logic 204 that may select a radio frequency to be used for establishing and maintaining a PDU session based on binding information. For example, RF binding logic 204 may store the binding information obtained via a control plane message from the network.

FIG. 2B illustrates exemplary binding information 230. As illustrated, binding information 230 includes radio frequency data correlated to other types of data. For example, a table may include a radio frequency field 232, an application field 234, an access device ID field 236, and a precedence field 238. As further illustrated, the table includes entries 240-1 and 240-2 (also referred to as entries 240 and generally or individually as entry 240) that each includes a grouping of fields 232 through 238 that are correlated. The binding information is illustrated in tabular form merely for the sake of description. In this regard, the binding information may be implemented in a data structure different from a table (e.g., a list, a flat file, etc.). The number of entries and the number and type of fields are exemplary. For example, the number of entries may depend on the number of candidate radio frequencies for a given PDU session and/or application. Also, fewer or additional fields of data may be correlated to the radio frequency and application data pair of fields 232 and 234. For example, the binding information may include a field that indicates a RAT (e.g., 5G, 5G Advanced), a deployment mode (e.g., SA, NSA, etc.), and/or other data (e.g., DC, etc.), as described herein, that relates to a radio connection between end device 130 and access device 107. According to some exemplary embodiments, the binding information may be implemented as a UE Route Selection Policy (URSP).

Radio frequency field 232 may include data that indicates a radio frequency, a carrier frequency, a frequency band, an operating band, channel information, duplex mode, or the like.

Application field 234 may include data that indicates an application. For example, application field 234 may include a unique application ID, a category of an application (e.g., mission-critical, Internet, video streaming, etc.), or the like.

Access device ID field 236 may include data that indicates an identifier for access device 107-1 to which the radio frequency of field 232 pertains.

Precedence field 238 may include data indicating a priority value. For example, the priority value for entry 240-1 may be different than the priority value for entry 240-2. Depending on the number of candidate and available radio frequencies for a given PDU session, according to some exemplary embodiments, RF binding logic 204 may select the radio frequency based on the priority value. According to other exemplary embodiments in which precedence or priority values are omitted in the binding information, RF binding logic 204 may select the radio frequency from multiple and available candidate radio frequencies based on other configurable criteria (e.g., a radio frequency being used for another PDU session, etc.).

Referring back to FIG. 2A, RF binding logic 204 (or other logic of end device 130) may provide UE capability information and/or UE assistance information to the network. For example, the UE capability or assistance information may indicate the radio frequencies and RAT(s) that are supported by end device 130 that may be applicable to provisioning of the binding information, as described herein. The UE capability or assistance information may include other well-known parameters (e.g., pertaining to the capabilities of end device 130). According to some exemplary embodiments, the UE capability or assistance information may be provided as a part of a registration procedure, during a time when end device 130 is in a Radio Resource Control (RRC) connected state, or as a part of another procedure (e.g., a tracking area update (TAU) procedure, a mobility update procedure (e.g., associated with a registration area (RA)), a handover procedure, etc.). According to other exemplary embodiments, an information element (IE), an attribute value pair, protocol configuration options (PCO) data, an extended PCO data, feature set data, or the like may include UE capability or assistance information in a control plane message, such as a PDU session establishment request message. According to still other exemplary embodiments, UE capability and/or assistance information may be included in user or end device profile information associated with end device 130. For example, a UDM/UDR may store this information, which may be obtained (e.g., directly or indirectly) by access device 107-2 or core device 122 of FIG. 2A, as described herein.

Access device 107-1 may include RF binding logic 206 that may validate a radio connection to be used for establishing and maintaining a PDU session based on binding information. For example, according to an exemplary scenario, a gNB, a DU, or another type of wireless station may identify an application associated with a PDU session establishment request and the radio frequency associated with the RRC connection and compare this information to binding information. According to another exemplary scenario, access device 107-1 may perform a validation procedure relative to a QoS flow during the PDU session. Access device 107-1 may be provisioned with the binding information by access device 107-2 or core device 122, as described herein. For example, access device 107-1 may receive a control plane message, which may be directed to end device 130, that includes the binding information. According to other examples, access device 107-1 may be independently provisioned with its own control plane message (e.g., from access device 107-2 or core device 122).

Depending on the embodiment or configuration, access device 107-2 or core device 122 may include RF binding logic 208. According to an exemplary embodiment, RF binding logic 208 may dynamically generate or select the binding information for a PDU session and end device 130, as described herein. According to an exemplary embodiment, RF binding logic 208 may include AI/ML logic that includes an AI/ML model. For example, the model may be implemented as a neural network model (NNM) and/or another type of model (e.g., a Generalized Linear Model (GLM), etc.). According to an exemplary embodiment, the radio spectrum binding service may use an optimization algorithm, such as a reinforcement learning algorithm or another type of learning algorithm (e.g., supervised learning, etc.). The goal of the optimization may be configurable. For example, the optimization may relate to radio frequency load balancing at access device 107-1. According to other examples, the optimization may relate to QoS, service level agreement (SLA) adherence, or another type of performance metric pertaining to an application of relevance associated with the PDU session. According to an exemplary embodiment, the AI/ML logic of the radio spectrum binding service may use network topology information and the performance metric information to generate the binding information, as described herein. Additionally, according to an exemplary embodiment, the AI/ML logic may evaluate radio frequencies, their characteristics and associated properties (e.g., wavelength, diffraction, etc.) in relation to the applications/categories of applications, performance metric information and network topology information (e.g., terrain within a sector, a sub-sector, etc.) to enable optimization of the available radio frequencies to support PDU sessions and various performance metrics (e.g., bitrate, throughput, latency, signal-to-noise (SNR), signal-to-interference-plus-noise (SINR), packet error rate, etc.).

RF binding logic 208 may store or have access to network topology information of access network 105 or a portion of access network 105. The network topology information may indicate the type and placement of access devices 107. The network topology information may include access device identifiers. The network topology information may include information relating to components of access devices 107, such as antennas (e.g., height, number, type, gain, transmit loss, receive loss, receive signal, fade margin (e.g., thermal, effective, etc.), and other characteristics (e.g., carrier frequencies, frequency bands, cells, radio access technology (RAT), cell coverage, sector coverage, sub-sector/zone coverage)) and configurations (e.g., CA, DC, CoMP, etc.). The network topology information may include map information, terrain (e.g., buildings, vegetation, roads, etc.) associated with a cell, a sector, a sub-sector of access device 107, and so forth.

RF binding logic 208 may receive performance metric parameters and values, which may include key performance indicators (KPIs), QoS parameters and values, Quality of Experience (QoE) parameters and values, SLA parameters and values, and/or Mean Opinion Score (MOS) parameters and values. A performance metric value may be implemented as a single value (e.g., X) or a range of values (e.g., X to Y). The performance metric value may also be associated with a time period (e.g., seconds, hour(s), day(s), and/or another time period), may indicate an average value, a mean value, and/or another statistical value. By way of further example, the performance metric information may relate to the performance associated with PDU sessions, connections, channels, messaging, a network procedure (e.g., attachment, handover, session establishment, local breakout, dual connectivity, etc.), application services, and/or other types of metrics in relation to a network element and/or a geographic area associated with a service. The performance metric information may relate to user plane or user plane and control plane events or metrics. As an example, the performance metric information may include information relating to RRC setup failures, handover attempts, handover failures, radio bearer drops, uplink and/or downlink throughput, voice call drops, network slice performance, random access failures, data volume (e.g., maximum, minimum, etc.), latency, packet error, delay, bit rates (e.g., guaranteed, maximum, minimum, burst, etc.), jitter, retries, 5G QCIs and characteristics, and so forth.

RF binding logic 208 may provision end device 130 with binding information based on UE capability or assistance information associated with end device 130 and capabilities of access device 107-1 included in the network topology information. For example, RF binding logic 208 may generate or select binding information for a PDU session as a part of a PDU session establishment procedure or other types of network procedures, as described herein. RF binding logic 208 may provision or provide the binding information to end device 130 and access device 107-1 in a control plane message. For example, when core device 122 is implemented as a PCF, a split PCF, or another type of policy control device, the binding information may be provided to end device 130 and access device 107-1 via an SMF and/or an AMF. Alternatively, for example, when access device 107-2 is implemented as a RIC or another type of controller, the RIC may provide the binding information to access device 107-1 and end device 130 (e.g., via access device 107-1).

As illustrated, according to exemplary process 200, end device 130 may generate and transmit a request 212. Request 212 may be implemented as a control plane message. For example, according to an exemplary scenario, request 212 may be implemented as a PDU session establishment request. According to other exemplary scenarios in which a PDU session has already been established, request 212 may be implemented as another type of request (e.g., a handover request, a TAU or mobility procedure request, etc.), which may or may not include a binding information request. Alternatively, the request may be implemented as a binding information request. According to various exemplary embodiments, the binding information request may include data indicating an application ID associated with the PDU session and data indicating a request for (updated) binding information. Additionally, the binding request may include the current radio frequency associated with the PDU session.

According to some exemplary embodiments, context information associated with the current or active PDU session and/or end device 130, may be stored by access device 107-1 or another core device 122 (e.g., an SMF and/or an AMF). For example, the context information may include at least a portion of the binding information and other types of information, such as an end device identifier (e.g., a subscription permanent identifier (SUPI) of end device 130 or the like), a PDU session ID, and so forth. Thus, the content of the other type of request (e.g., a binding information request, a handover request, a handover request that includes a binding information request, etc.) may vary according to various exemplary embodiments but allow access device 107-2 or core device 122 to select appropriate binding information (which may or may not require updating).

However, according to the exemplary scenario depicted in FIG. 2A, assume that request 212 is a PDU session establishment request. The PDU session establishment request may include data according to a network standard (e.g., 3GPP or the like). According to various exemplary implementations, the PDU session establishment request may or may not include UE capability or assistance information (e.g., included as PCO data, etc.). According to an exemplary embodiment, the PDU session establishment request may include data indicating an application identifier and/or a category of an application to which the PDU session to be established pertains.

Although not shown, the PDU session establishment request may be transmitted to an AMF via access device 107-1. According to the exemplary scenario, assume that core device 122 (e.g., a PCF, split PCF, or another type of policy control device) is implemented for purposes of the description of process 200. As such, the AMF may perform a policy association/retrieval procedure to obtain AM and UE policies from a PCF or split PCF, for example. The AMF may further select an SMF and the SMF may perform a similar procedure to obtain SM policies from the PCF or an SM-PCF, for example. According to various exemplary embodiments, the AMF or the SMF may transmit a policy request 214 to core device 122. According to some exemplary implementations, in addition to data that may be included in accordance with a network standard for policy retrieval associated with a PDU session establishment procedure, policy request 214 may include a request for binding information. For example, policy request 214 may include the application identifier and/or the category of the application. Policy request 214 may include other types of data that enable core device 122 to select the appropriate candidate radio frequencies, such as UE capability or assistance information, access device identifier for access device 107-1, and other information of relevance, as described herein.

As illustrated, in response to receiving policy request 214, core device 122 may analyze the request 215. For example, core device 122 may read and analyze data included in policy request 214. RF binding logic 208 of core device 122 may perform a lookup for binding information based on the analysis and available information. For example, core device 122 may search or perform a lookup in the binding information based on the application and/or the category of the application associated with the prospective PDU session, the UE capability and assistance information associated with end device 130, network topology information associated with access device 107-1 (e.g., including capability information) and potentially other access devices 107 that may be neighbors and available candidates to support the radio connection for the PDU session, and other available information, as described herein. As a result of the lookup or search procedure, core device 122 may select binding information 217.

As further illustrated, core device 122 may generate and transmit the binding information 218. For example, a policy response 219 may include the binding information, which may be communicated to the SMF or the AMF, for example (not illustrated). The binding information may be provided to access device 107-1 and a response 220 may include the binding information, which is transmitted to end device 130. For example, a PDU session establishment accept message or another type of control plane message may be transmitted to end device 130. In response to receiving response 220, RF binding logic 204 of end device 130 may select 222 a radio frequency based on the binding information, as described herein. End device 130 may establish a PDU session 224 using the selected radio frequency. For example, end device 130 may establish a PDU session 210-1 via a first radio frequency and a first application. Subsequently, according to a similar process, end device 130 may establish a PDU session 210-2 via a second radio frequency and a second application. For example, the first radio frequency and second radio frequency may be different from each other and the first and second applications may relate to different application categories. Although not illustrated, end device 130 may establish PDU sessions 210-1 and 210-2 via a UPF to an external device 117, as described herein.

FIG. 2A illustrates exemplary steps or operations of process 200, however, according to other exemplary embodiments, process 200 may include additional, different, and/or fewer steps or operations than those illustrated and described in relation to FIG. 2. For example, when the provisioning of the binding information is performed by access device 107-2, access device 107-1 may transmit a request for binding information. The request may include the application and/or the category of the application identifier. Access device 107-2 may perform similar operations to those described in relation to core device 122, and provide a response that includes the binding information to access device 107-2,, which in turn may provide this information to end device 130. Although process 200 describes and illustrates exemplary control plane messaging, according to other exemplary embodiments, dedicated control plane messaging may be implemented or other types of control plane messaging associated with other types of network procedures may be used.

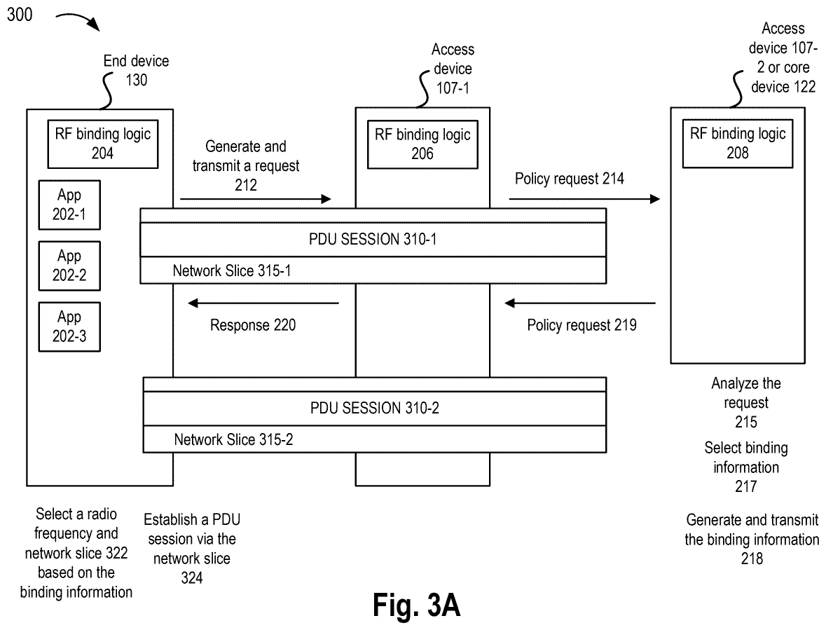

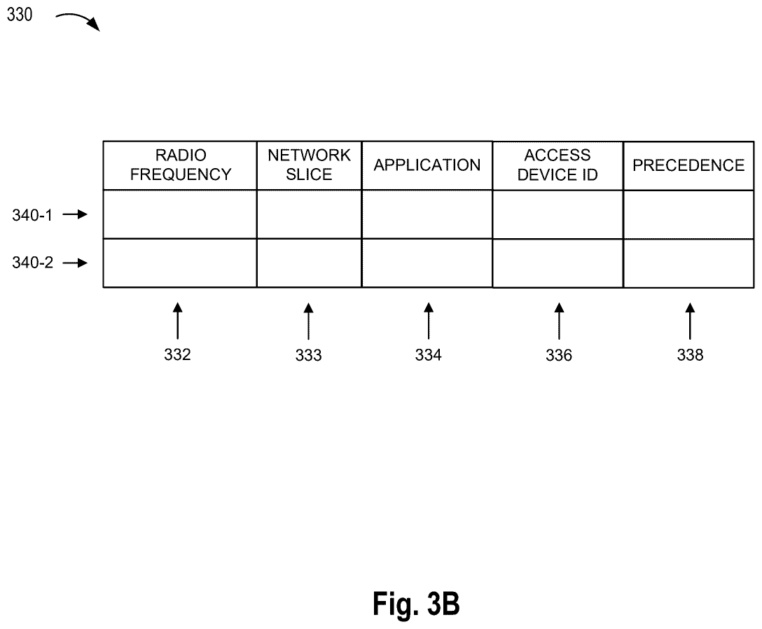

FIG. 3A is a diagram illustrating an exemplary process 300 of an exemplary embodiment of the radio spectrum binding service implemented in an exemplary environment. In contrast to process 200, process 300 may include that the binding information correlates a radio frequency to a network slice. Alternatively, the binding information may correlate a radio frequency to a PDU session and a network slice. The steps or operations previously described in relation to process 200 may generally be applicable to those for process 300 with some modification. For example, end device 130 may include network slice information (e.g., approved single-network slice assistance information (S-NSSAI) associated with its subscription) in the request. Alternatively, for example, the AMF may obtain information during registration with end device 130, from the SMF, or from an NSSF, for example. Additionally, for example, core device 122 may generate or select binding information, which includes a network slice.

FIG. 3B illustrates exemplary binding information 330. As illustrated, binding information 330 includes radio frequency data correlated to other types of data. For example, a table may include a radio frequency field 332, a network slice field 333, an application field 334, an access device ID field 336, and a precedence field 338. As further illustrated, the table includes entries 340-1 and 340-2 (also referred to as entries 340 and generally or individually as entry 340) that each includes a grouping of fields 332 through 338 that are correlated. The binding information is illustrated in tabular form merely for the sake of description. Similar to binding information 230, fewer or additional fields of data may be correlated to the radio frequency field 332. For example, the binding information may include a field that indicates a RAT (e.g., 5G, 5G Advanced), a deployment mode (e.g., SA, NSA, etc.), and/or other data (e.g., DC, etc.), as described herein, that relates to a radio connection between end device 130 and access device 107. According to some exemplary embodiments, the binding information may be implemented as a URSP.

Fields 332, 334, 336, and 338 may store data corresponding to fields 232, 234, 236 and 238 of binding information 230, as previously described. Network slice field 333 may include data that identifies a network slice. For example, network slice field 333 may store S-NSSAI or a portion of such information (e.g., slice differentiator (SD) information), as described herein.

Referring back to FIG. 3A, in response to receiving policy request 214, core device 122 may analyze the request 215. For example, core device 122 may read and analyze data included in policy request 214. In contrast to process 200, policy request 214 may include approved S-NSSAI pertaining to end device 130. RF binding logic 208 of core device 122 may perform a lookup for binding information based on the analysis and available information. For example, core device 122 may search or perform a lookup in the binding information based on the application and/or the category of the application associated with the prospective PDU session, the UE capability and assistance information associated with end device 130, network topology information associated with access device 107-1 (e.g., including capability information) and potentially other access devices 107 that may be neighbors and available candidates to support the radio connection for the PDU session, and other available information (e.g., including S-NSSAI of end device 130), as described herein. As a result of the lookup, core device 122 may select binding information 217.

As further illustrated, core device 122 may generate and transmit the binding information 218. For example, a policy response 219 may include the binding information, which may be communicated to the SMF or the AMF, for example (not illustrated). The binding information may be provided to access device 107-1 and a response 220 may include the binding information, which is transmitted to end device 130.

In response to receiving response 220, RF binding logic 204 of end device 130 may select a radio frequency and a network slice 322 based on the binding information, as described herein. End device 130 may establish a PDU session via the network slice 324 using the selected radio frequency and network slice. For example, end device 130 may establish a PDU session 310-1 via a first radio frequency, a first application, and a first network slice 315-1. Subsequently, according to a similar process, end device 130 may establish a PDU session 310-2 via a second radio frequency, a second application, and a second network slice 315-2. For example, the first radio frequency and second radio frequency may be different from each other, the first and second applications may relate to different application categories, and the network slices may be different. Although not illustrated, end device 130 may establish PDU sessions 210-1 and 210-2 via a UPF and network slices 315 to external devices 117, as described herein.

FIG. 3A illustrates exemplary steps or operations of process 300, however, according to other exemplary embodiments, process 300 may include additional, different, and/or fewer steps or operations than those illustrated and described in relation to FIG. 3. For example, when the provisioning of the binding information is performed by access device 107-2, access device 107-1 may transmit a request for binding information. The request may include the application and/or the category of the application identifier. Access device 107-2 may perform similar operations to those described in relation to core device 122, and provide a response that includes the binding information to access device 107-2,, which in turn may provide this information to end device 130. Although process 300 describes and illustrates exemplary control plane messaging, according to other exemplary embodiments, dedicated control plane messaging may be implemented or other types of control plane messaging associated with other types of network procedures may be used.

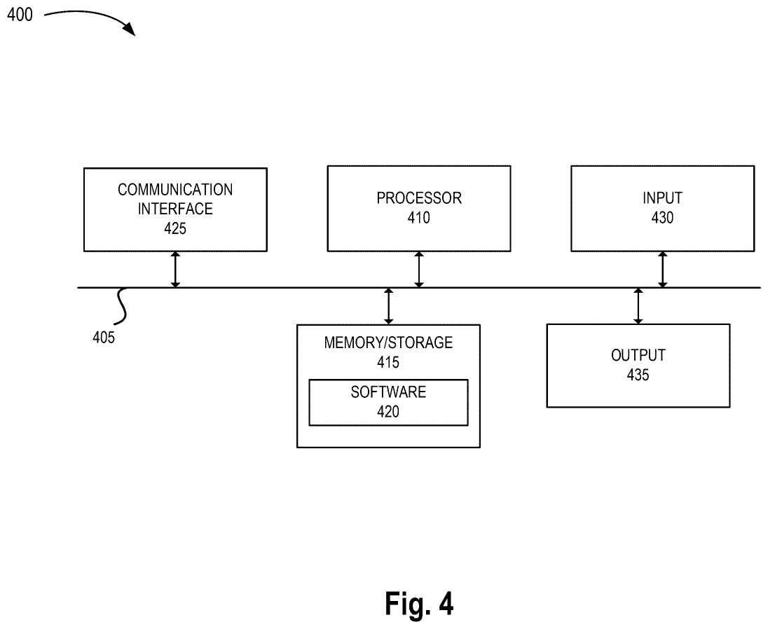

FIG. 4 is a diagram illustrating exemplary components of a device 400 that may be included in one or more of the devices described herein. For example, device 400 may correspond to access device 107, external device 117, core device 122, end device 130, and/or other types of network devices, as described herein. As illustrated in FIG. 4, device 400 includes a bus 405, a processor 410, a memory/storage 415 that stores software 420, a communication interface 425, an input 430, and an output 435. According to other embodiments, device 400 may include fewer components, additional components, different components, and/or a different arrangement of components than those illustrated in FIG. 4 and described herein.

Bus 405 includes a path that permits communication among the components of device 400. For example, bus 405 may include a system bus, an address bus, a data bus, and/or a control bus. Bus 405 may also include bus drivers, bus arbiters, bus interfaces, clocks, and so forth.

Processor 410 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 410 may be implemented as hardware (e.g., a microprocessor, etc.), a combination of hardware and software (e.g., a SoC, an ASIC, etc.), may include one or multiple memories (e.g., cache, etc.), etc.

Processor 410 may control the overall operation, or a portion of operation(s) performed by device 400. Processor 410 may perform one or multiple operations based on an operating system and/or various applications or computer programs (e.g., software 420). Processor 410 may access instructions from memory/storage 415, from other components of device 400, and/or from a source external to device 400 (e.g., a network, another device, etc.). Processor 410 may perform an operation and/or a process based on various techniques including, for example, multithreading, parallel processing, pipelining, interleaving, learning, model-based, etc.

Memory/storage 415 includes one or multiple memories and/or one or multiple other types of storage mediums. For example, memory/storage 415 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 415 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 415 may be external to and/or removable from device 400, such as, for example, a Universal Serial Bus (USB) memory stick, a dongle, a hard disk, mass storage, off-line storage, or some other type of storing medium. Memory/storage 415 may store data, software, and/or instructions related to the operation of device 400.

Software 420 includes an application or a program that provides a function and/or a process. As an example, with reference to end device 130, software 420 may include an application that, when executed by processor 410, provides a function and/or a process of the radio spectrum binding service, as described herein. According to another example, with reference to access device 107-2 and core device 122, software 420 may include an application that, when executed by processor 410, provides a function and/or a process of the radio spectrum binding service, as described herein. Software 420 may also include firmware, middleware, microcode, hardware description language (HDL), and/or another form of instruction. Software 420 may also be virtualized. Software 420 may further include an operating system (OS) (e.g., Windows, Linux, Android, proprietary, etc.).

Communication interface 425 permits device 400 to communicate with other devices, networks, systems, and/or the like. Communication interface 425 includes one or multiple wireless interfaces, optical interfaces, and/or wired interfaces. For example, communication interface 425 may include one or multiple transmitters and receivers, or transceivers. Communication interface 425 may operate according to a protocol stack and a communication standard.

Input 430 permits an input into device 400. For example, input 430 may include a keyboard, a mouse, a display, a touchscreen, a touchless screen, a button, a switch, an input port, speech recognition logic, and/or some other type of visual, auditory, tactile, affective, olfactory, etc., input component. Output 435 permits an output from device 400. For example, output 435 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 400 may be implemented in the same manner. For example, device 400 may be instantiated, created, deleted, or some other operational state during its life cycle (e.g., refreshed, paused, suspended, rebooted, or another type of state or status), using well-known virtualization technologies. For example, access device 107, core device 122, external device 117, and/or another type of network device or end device 130, as described herein, may be a virtualized device.

Device 400 may be configured to perform a process and/or a function, as described herein, in response to processor 410 executing software 420 stored by memory/storage 415. By way of example, instructions may be read into memory/storage 415 from another memory/storage 415 (not shown) or read from another device (not shown) via communication interface 425. The instructions stored by memory/storage 415 may configure device 400 and/or cause processor 410 to perform a function or a process described herein. Alternatively, for example, according to other implementations, device 400 may be configured to perform a function or a process described herein based on the execution of hardware (processor 410, etc.).

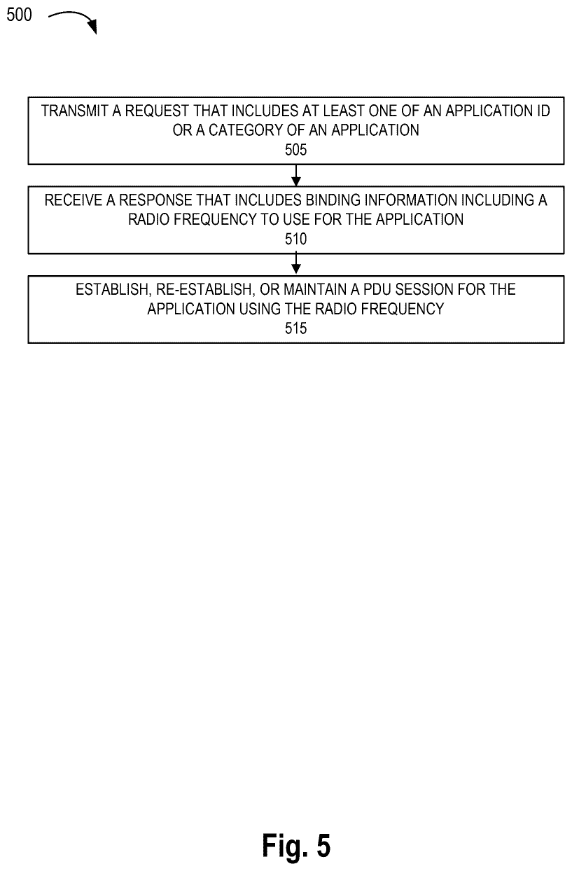

FIG. 5 is a flow diagram illustrating an exemplary process 500 of an exemplary embodiment of the radio spectrum binding service. According to an exemplary embodiment, process 500 may be implemented by end device 130. According to an exemplary implementation, a processor may execute software to perform a step (in whole or in part) of process 500, as described herein. Alternatively, a step (in whole or in part) may be performed by execution of only hardware. According to an exemplary embodiment of process 500, end device 130 may be registered with core network 120.

In block 505, end device 130 may transmit a request that includes at least one of an application ID or a category of an application. The request may also include an end device identifier of end device 130 and/or UE capability or assistance information. The request may be implemented as a control plane message. The request may be transmitted to an access device 107-2, such as a RIC, a BSC, or the like, a core device 122, such as a PCF, a split PCF, or the like, or a dedicated network device, as described herein. According to an exemplary embodiment, end device 130 may be initiating a PDU session establishment (e.g., in response to an initial execution of the application at end device 130). According to other exemplary embodiments, end device 130 may be re-establishing or maintaining an existing PDU session in which the request may be triggered based on another network procedure, as described herein.

In block 510, end device 130 may receive a response that includes binding information including a radio frequency to use for the application. For example, the response may be implemented as a control plane message responsive to the request of block 505. According to various exemplary scenarios, the binding information may include a single binding instance information or multiple binding instances information. When there are multiple instances of binding information, end device 130 may select the radio frequency based on the priority value or other configurable criteria, as described herein. The binding information may include other data in addition to the radio frequency, as described herein.

In block 515, end device 130 may establish, re-establish, or maintain a PDU session for the application using the radio frequency. For example, end device 130 may establish the PDU session (e.g., with external device 117) using the radio frequency obtained in the binding information. According to other examples, such as during a handover or user mobility from on-net to roaming, end device 130 may re-establish or maintain an existing PDU session using the radio frequency, which may or may not be the same as the radio frequency used when the PDU session was initially established.

FIG. 5 illustrates exemplary steps or operations of process 500, however, according to other exemplary embodiments, process 500 may include additional, different, and/or fewer steps or operations than those illustrated and described in relation to FIG. 5. For example, according to other exemplary embodiments, the request may include network slice information and/or other types of information, as described herein. The end device may establish, re-establish, or maintain the PDU session using the radio frequency and the network slice information, as described herein.

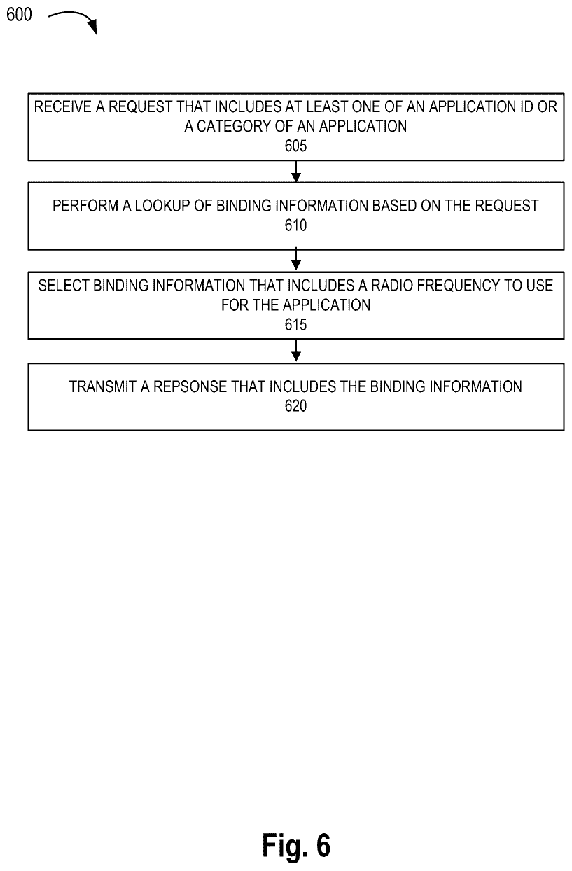

FIG. 6 is another flow diagram illustrating still another exemplary process 600 of an exemplary embodiment of the radio spectrum binding service. According to an exemplary embodiment, process 600 may be implemented by core device 122 or access device 107. According to an exemplary implementation, a processor may execute software to perform a step (in whole or in part) of process 600, as described herein. Alternatively, a step (in whole or in part) may be performed by execution of only hardware. For purposes of description, process 600 is described as being performed by core device 122.

In block 605, core device 122 may receive a request that includes at least one of an application identifier or a category of an application. The request may also include an end device identifier of end device 130 and/or UE capability or assistance information. The request may be implemented as a control plane message. According to various exemplary embodiments, the request may be a policy request or a binding request, as described herein. The policy request or the binding request may relate to a PDU session establishment or other type of PDU session procedure, as described herein.

In block 610, core device 122 may perform a lookup of binding information based on the request. For example, core device 122 may generate and update binding information, as described herein. The binding information may include correlations between radio frequencies and applications, among other types of information, as described herein. Core device 122 may perform the lookup based on other types of information (e.g., UE capability or assistance information, network topology information, performance metric information, etc.), as described herein.

In block 615, core device 122 may select binding information that includes a radio frequency to use for the application. For example, core device 122 may select one or multiple candidate radio frequencies for use with a radio connection and a PDU session.

In block 620, core device 122 may transmit a response that includes the binding information. For example, core device 122 may transmit the response towards end device 130 to which the request pertains, as described herein.

FIG. 6 illustrates exemplary steps or operations of process 600, however, according to other exemplary embodiments, process 600 may include additional, different, and/or fewer steps or operations than those illustrated and described in relation to FIG. 6. For example, according to other exemplary embodiments, the request may include network slice information and/or other types of information, as described herein. Additionally, the binding information may include correlations with radio frequencies, applications, and network slices, for example. Process 600 may include other operations, such as generating or updating the binding information based on AI/ML logic, as described herein.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,”“implementations,”etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while series of blocks have been described regarding the processes illustrated in FIGS. 5 and 6, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 410, etc.), or a combination of hardware and software (e.g., software 420).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 410) of a device. A non-transitory storage medium includes one or more of the storage mediums described in relation to memory/storage 415. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
receiving, by a network device, a request for a radio frequency to use for a packet data unit (PDU) session associated with an end device, wherein the request includes at least one of an application identifier or a category of an application to which the PDU session pertains and capability information associated with the end device;
selecting, by the network device based on the request, one or more radio frequencies;
generating, by the network device, a response that includes the one or more radio frequencies; and
transmitting, by the network device, the response towards the end device.

2. The method of claim 1, wherein the request is also for a network slice to use for the PDU session, and wherein the response further includes one or more network slice identifiers, and wherein the one or more radio frequencies and the one or more network slice identifiers are correlated.

3. The method of claim 1, further comprising:
generating, by the network device, binding information that includes correlations between radio frequencies, applications, and network slice identifiers, based on network topology information and performance metric information.

4. The method of claim 1, further comprising:
performing, by the network device, a lookup procedure of binding information, wherein the binding information includes correlations between radio frequencies, applications, and network slice identifiers.

5. The method of claim 1, wherein the request further includes capability information pertaining to a radio access device to which the end device is connected.

6. The method of claim 1, wherein the request includes network slice identifiers approved for the end device.

7. The method of claim 1, wherein the request is received prior to an establishment of the PDU session.

8. The method of claim 1, wherein the network device is a policy control function (PCF) or a split PCF, and wherein the request is a policy request for at least one of session management (SM) policies, user equipment (UE) policies, or access and mobility management (AM) policies pertaining to the PDU session.

9. A network device comprising:
a processor, wherein the processor is configured to:
receive a request for a radio frequency to use for a packet data unit (PDU) session associated with an end device, wherein the request includes at least one of an application identifier or a category of an application to which the PDU session pertains and capability information associated with the end device;
select, based on the request, one or more radio frequencies;
generate a response that includes the one or more radio frequencies; and
transmit the response towards the end device.

10. The network device of claim 9, wherein the request is also for a network slice to use for the PDU session, and wherein the response further includes one or more network slice identifiers, and wherein the one or more radio frequencies and the one or more network slice identifiers are correlated.

11. The network device of claim 9, wherein the processor is further configured to:
generate binding information that includes correlations between radio frequencies, applications, and network slice identifiers, based on network topology information and performance metric information.

12. The network device of claim 9, wherein the processor is further configured to:
perform a lookup procedure of binding information, wherein the binding information includes correlations between radio frequencies, applications, and network slice identifiers.

13. The network device of claim 9, wherein the request further includes capability information pertaining to a radio access device to which the end device is connected.

14. The network device of claim 9, wherein the request includes network slice identifiers approved for the end device.

15. The network device of claim 9, wherein the request is received prior to an establishment of the PDU session.

16. The network device of claim 9, wherein the network device is a policy control function (PCF) or a split PCF, and wherein the request is a policy request for at least one of session management (SM) policies, user equipment (UE) policies, or access and mobility management (AM) policies pertaining to the PDU session.

17. A non-transitory computer-readable storage medium storing instructions executable by a processor of a network device, wherein the instructions are configured to:
receive a request for a radio frequency to use for a packet data unit (PDU) session associated with an end device, wherein the request includes at least one of an application identifier or a category of an application to which the PDU session pertains and capability information associated with the end device;
select, based on the request, one or more radio frequencies;
generate a response that includes the one or more radio frequencies; and
transmit the response towards the end device.

18. The non-transitory computer-readable storage medium of claim 17, wherein the request is received prior to an establishment of the PDU session.

19. The non-transitory computer-readable storage medium of claim 17, wherein the instructions are further configured to:
generate binding information that includes correlations between radio frequencies, applications, and network slice identifiers, based on network topology information and performance metric information.

20. The non-transitory computer-readable storage medium of claim 17, wherein the instructions are further configured to:
perform a lookup procedure of binding information, wherein the binding information includes correlations between radio frequencies, applications, and network slice identifiers.
